(19) United States
(12) Patent Application Publication
(10) Pub. No.: US 2026/0133936 A1
(43) Pub. Date: May 14, 2026

(54) GENERATING A COMPATIBLE FILENAME FOR A CONTENT ITEM AND A FILENAME MAPPING THAT MAPS AN ORIGINAL FILENAME OF THE CONTENT ITEM TO THE COMPATIBLE FILENAME

(71) Applicant: Dropbox, Inc., San Francisco, CA (US)

(72) Inventors: Joshua Warner, Albany, CA (US); Geoffry Song, San Francisco, CA (US); Patrick Jennings, San Francisco, CA (US)

(21) Appl. No.: 18/941,318

(22) Filed: Nov. 8, 2024

(51) Int. Cl. G06F 16/16

(52) U.S. Cl. CPC G06F 16/164

(57) ABSTRACT

The present disclosure relates to systems, non-transitory computer-readable media, and methods for generating a compatible filename for a content item and generating a filename mapping that maps an original filename for the content item to the compatible filename. In particular, in one or more embodiments, the disclosed systems determine that the original filename for the content item at a first storage location is incompatible with filename conventions at a second storage location and generate a compatible filename for synchronizing the content item to the second storage location. The disclosed systems can also generate a filename mapping that maps the original filename to the compatible filename and, upon receiving an interaction with the content item, the disclosed systems utilize the filename mapping to a propagate modification to the content item at both the first storage location and the second storage location.

### BACKGROUND

Recent years have seen significant improvements in storage systems that can synchronize and store digital items (e.g., computer data and files) across multiple devices and systems. For example, conventional storage systems can store data and digital items on servers and synchronize the data and digital items to computing devices, and vice versa, syncing data and digital items stored on computing devices to servers. To illustrate, conventional storage systems can synchronize modifications of a content item so that accessing the content item directly from either the server or from the computing device would result in viewing updated versions of both instances of the content item. Although conventional storage systems can synchronize content items across devices and servers, such systems have a number of problems in relation to accuracy, efficiency, and flexibility of operation.

For instance, conventional storage systems are inflexible. Specifically, conventional storage systems are limited in synchronizing digital items between storage locations associated with various servers and/or client devices. For example, operating systems for servers and/or client devices have different rules for characters that are allowed for use within filenames, where one storage location may allow certain characters in a filename, another storage location may not allow those certain characters. Indeed, even a single character in a filename may conflict with rules of another system and, in these cases, conventional storage systems cannot account for the differences and simply fail to synchronize digital items when filenames do not conform to conventions of a destination storage location.

In addition, the above-mentioned issues lead to conventional storage systems being inaccurate. As mentioned, conventional storage systems fail to synchronize digital items due to different rules and/or conventions at different storage locations due to differing filename conventions. For example, conventional storage systems store digital items at a server and utilize applications that install folders on native file management systems that synchronize digital items with the conventional storage system. However, because of different rules and conventions of operating systems associated with the native file management, conventional storage systems may not synchronize digital items with native file management systems, leading to inaccurate (or missing) folders, missing digital items, and inaccurate listings of digital items on either the server or the native file management system. Moreover, these synchronization failures due to filename issues are often not indicated in the conventional storage system or the native file management system—even interfaces that list synchronization issues. Indeed, an application of the conventional storage system may indicate that a digital item is stored at one location, while the native file management system simply does not show the digital item, with no indication that the digital item did not synchronize, leading to unknown inaccuracies within the native file management system.

In part due to their inaccuracies, conventional storage systems are also inefficient. Specifically, because conventional storage systems fail to synchronize digital items, and even fail to indicate they didn't synchronize the digital items, conventional storage systems require excess unnecessary computing power as client devices initiate multiple interfaces and perform multiple operations to identify where digital items are stored. For example, digital items are often listed in one location but not another location and client devices will initiate multiple interfaces and attempt to manually upload digital items, utilizing unnecessary computing and processing power that would not be required if systems were able to accurately synchronize digital items. These along with additional problems and issues exist with regard to conventional storage systems.

### SUMMARY

Embodiments of the present disclosure provide benefits and/or solve one or more of the foregoing or other problems in the art with systems, non-transitory computer-readable media, and methods for generating a compatible filename for a content item and generating a filename mapping that maps an original filename for the content item to the compatible filename. For example, in one or more embodiments, the disclosed systems determine that an original filename for a content item stored at a first location is incompatible with filename conventions at a second location and generate the compatible filename for storing the content item at the second location. In addition, the disclosed systems generate the filename mapping that maps the original filename for the content item at the first location to the compatible filename for the content item at the second location. Upon receiving an interaction with the content item, the disclosed systems propagate a modification to the content item at the first location and the second location using the filename mapping. In one or more embodiments, the disclosed systems compare filenames to generate a filename offset indicating modifications to a filename and modifying an additional filename based on the filename offset. Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates an example diagram of an overview of an intelligent file mapping system generating a compatible filename and a filename mapping for mapping an original filename to the compatible filename in accordance with one or more embodiments.

FIG. 2 illustrates a schematic diagram of an intelligent file mapping system generating a compatible local filename for a content item on a client device and generating and utilizing a filename mapping to propagate modifications to the content item at a server and a client device in accordance with one or more embodiments.

FIG. 3 illustrates a schematic diagram of an intelligent file mapping system generating a filename offset based on an updated local filename and utilizing the filename offset to generate an updated original filename in accordance with one or more embodiments.

FIG. 4 illustrates a schematic diagram of an intelligent file mapping system replacing characters in an original filename to generate a compatible filename in accordance with one or more embodiments.

FIG. 5 illustrates a schematic diagram of an intelligent file mapping system using a filename mapping to update a tree data model in accordance with one or more embodiments.

FIGS. 6A-6B illustrate example graphical user interfaces of an intelligent file mapping system displaying an original filename and a compatible filename in accordance with one or more embodiments.

FIG. 7 illustrates an example graphical user interface of an intelligent file mapping system providing an indication that compatible local filenames are replacing original filenames in accordance with one or more embodiments.

FIG. 8 illustrates an example graphical user interface of an intelligent file mapping system providing a collision notification in a file sync interface in accordance with one or more embodiments.

FIG. 9 illustrates an example graphical user interface of an intelligent file mapping system for receiving user preferences for modifying filenames in accordance with one or more embodiments.

FIG. 10 illustrates a schematic diagram of an environment in which an intelligent file mapping system can operate in accordance with one or more embodiments

FIG. 11 illustrates a flowchart of a series of acts for generating a compatible local filename and a filename mapping that maps an original filename to the compatible local filename in accordance with one or more embodiments.

FIG. 12 illustrates a flowchart of a series of acts for generating an updated original filename based on the

FIG. 13 illustrates a block diagram of an example computing device for implementing one or more embodiments of the present disclosure.

FIG. 14 illustrates a network environment of a content management system in accordance with one or more embodiments.

### DETAILED DESCRIPTION

This disclosure describes one or more embodiments of an intelligent file mapping system that generates a compatible filename for a content item and generates a filename mapping that maps the compatible filename for the content item to an original filename for the content item at an original storage location. In particular, the intelligent file mapping system determines that an original filename for the content item at a first location does not conform to filename conventions at a second location and generates the compatible filename for storing the content item at the second location. In some instances, the intelligent file mapping system generates the compatible filename by replacing incompatible characters in the original filename with compatible characters in the compatible filename. Further, the intelligent file mapping system generates the filename mapping to map the original filename for the content item at the first location to the compatible filename for the content item at the second location and uses the filename mapping to propagate interactions with (or modifications to) the content item to the first and second location using the filename mapping.

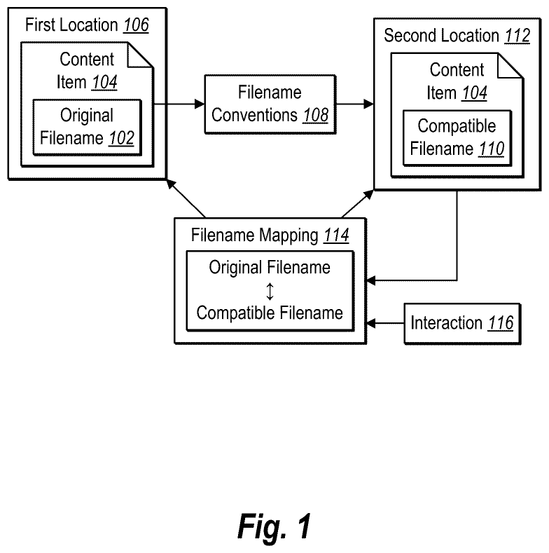

FIG. 1 illustrates an example overview of intelligent file mapping system 100 generating a compatible filename for a content item and generating a filename mapping that maps an original filename for the content item at a first location to the compatible filename at a second location in accordance with one or more embodiments. Specifically, the intelligent file mapping system 100 generates a compatible filename based on identifying that an original filename 102 for content item 104 stored at first location 106 does not comply with filename conventions 108 of second location 112. In response to determining to synchronize data to content item 104 from first location 106 to second location 112, the intelligent file mapping system 100 determines that original filename 102 for content item 104 does not comply with filename conventions 108 for second location 112. For example, in some instances, when original filename 102 does not comply with filename conventions 108, second location 112 will not synchronize content item 104 and/or will not display content item 104 in a file manager interface associated with second location 112.

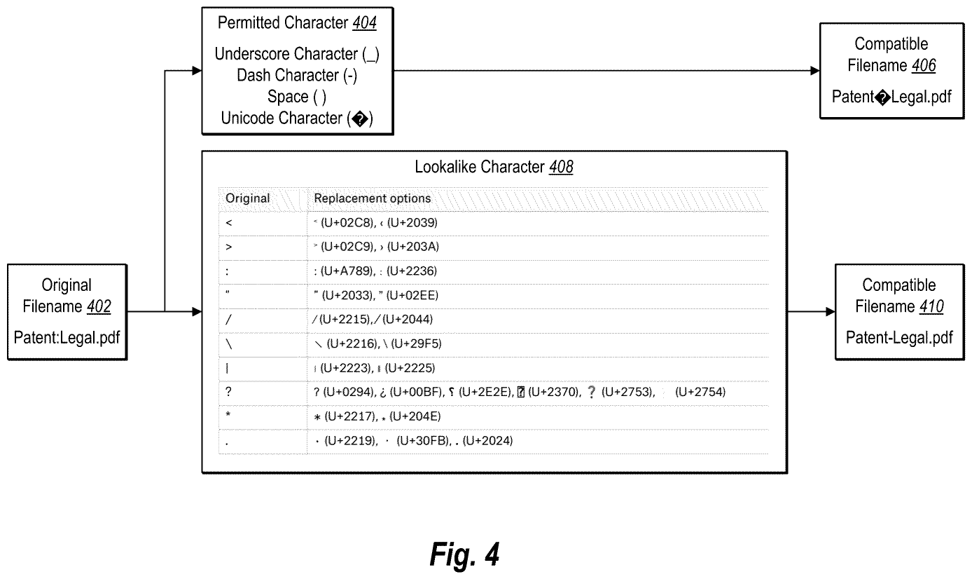

As just mentioned, in some embodiments the intelligent file mapping system 100 generates a compatible filename 110 for content item 104 for second location 112. For example, the intelligent file mapping system 100 generates compatible filename 110 by replacing incompatible characters in original filename 102 with compatible characters. Additional details regarding the intelligent file mapping system 100 replacing incompatible characters in the original filename and generating compatible filenames are provided below with respect to FIG. 4.

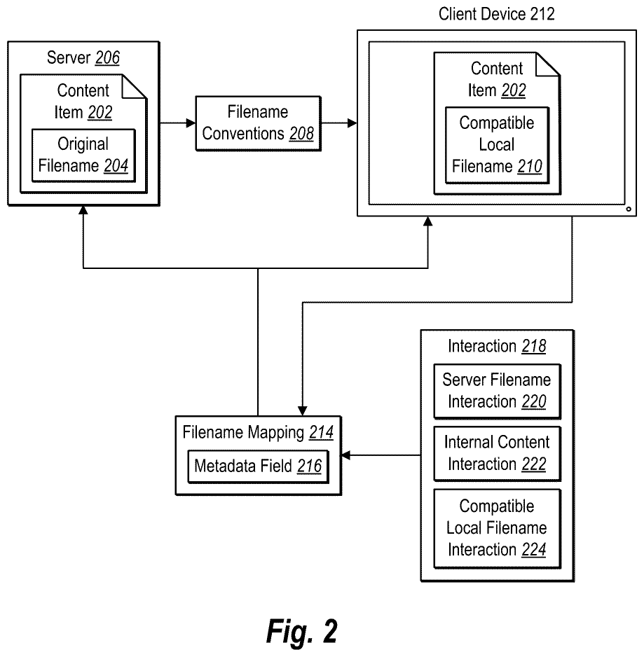

In one or more embodiments, the intelligent file mapping system 100 generates compatible filenames for syncing a content item stored at a sever to a client device. Specifically, the intelligent file mapping system 100 determines that a content item stored at a server does not conform to filename conventions for a client device. The intelligent file mapping system 100 generates a compatible local filename for content item 104 that conforms to the filename conventions of the client device. Additional detail regarding generating a compatible local filename for a content item at a client device are provided below with respect to FIG. 2.

As previously mentioned, in some embodiments, the intelligent file mapping system 100 generates filename mapping 114 that maps original filename 102 to compatible filename 110. For example, the intelligent file mapping system 100 generates filename mapping 114 for content item 104 that maps original filename 102 for content item 104 at first location 106 to compatible filename 110 of content item 104 at second location 112. As an illustration, the intelligent file mapping system 100 can generate filename mapping 114 that maps an original filename 102 “document>12345.pdf” at first location 106 to a compatible filename 110 “document_12345.pdf” at second location 112. Indeed, the intelligent file mapping system 100 can utilize filename mapping 114 to map original filename 102 and compatible filename 110 even if one of the locations has read-only access to content item 104.

In addition, as shown, in one or more embodiments, the intelligent file mapping system 100 utilizes filename mapping 114 to propagate modifications to content item 104. In particular, based on receiving indications of interaction 116 with content item 104, the intelligent file mapping system 100 utilizes filename mapping 114 to propagate modifications to content item 104. For example, based on receiving interaction 116 of content item 104 at the second location 112, the intelligent file mapping system 100 uses filename mapping 114 to identify original filename 102 for content item 104 and propagate the modification to content item 104 at first location 106.

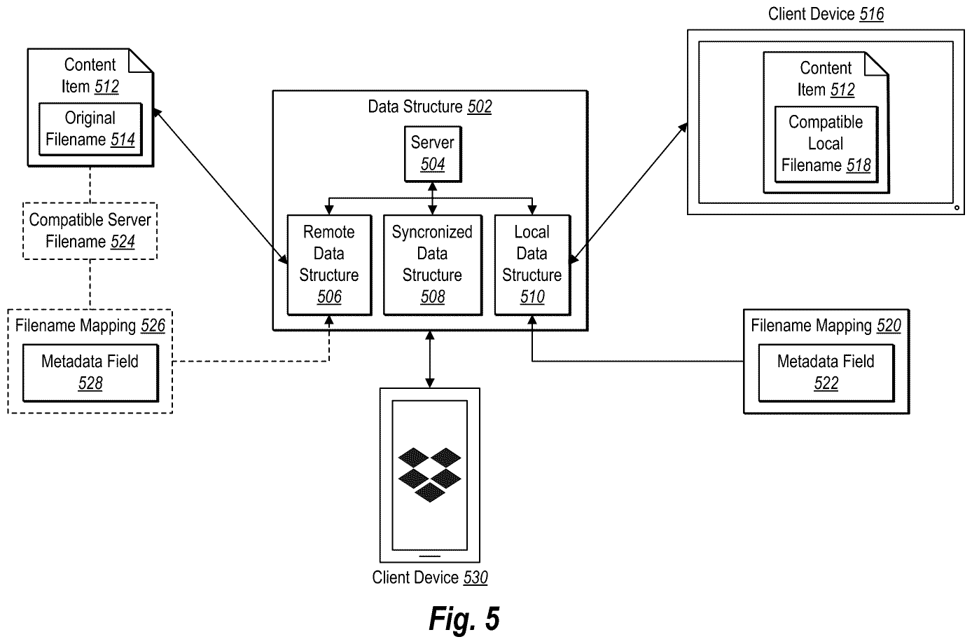

In one or more embodiments, the intelligent file mapping system 100 generates filename mapping 114 by generating a metadata field. In particular, the intelligent file mapping system 100 associates a metadata field with the content item 104 that identifies the original filename 102 at first location 106 and the compatible filename 110 at second location 112. In some cases, the intelligent file mapping system 100 generates a metadata field that is associated with (or attached directly to) content item 104. In other cases, the metadata field is stored at a data structure, such as a data tree associated with a location of content item 104. Additional details regarding the intelligent file mapping system 100 storing a filename mapping in a data structure are provided below with respect to FIG. 5 below.

The intelligent file mapping system 100 can also modify filename mapping 114 based on interaction 116. In some cases, the intelligent file mapping system 100 receives an indication of a modification of original filename 102 or compatible filename 110 and modifies (or updates) filename mapping 114 to reflect the modification. In other cases, the intelligent file mapping system 100 removes filename mapping 114. For example, if the intelligent file mapping system 100 receives an indication of a modification of compatible filename 110 at the second location 112 to a filename that is also compatible at first location 106, the intelligent file mapping system 100 can update original filename 102 and remove or otherwise disregard filename mapping 114. Additional details and examples of the intelligent file mapping system 100 updating or removing filename mapping 114 are provided below with respect to FIG. 2 and FIG. 5.

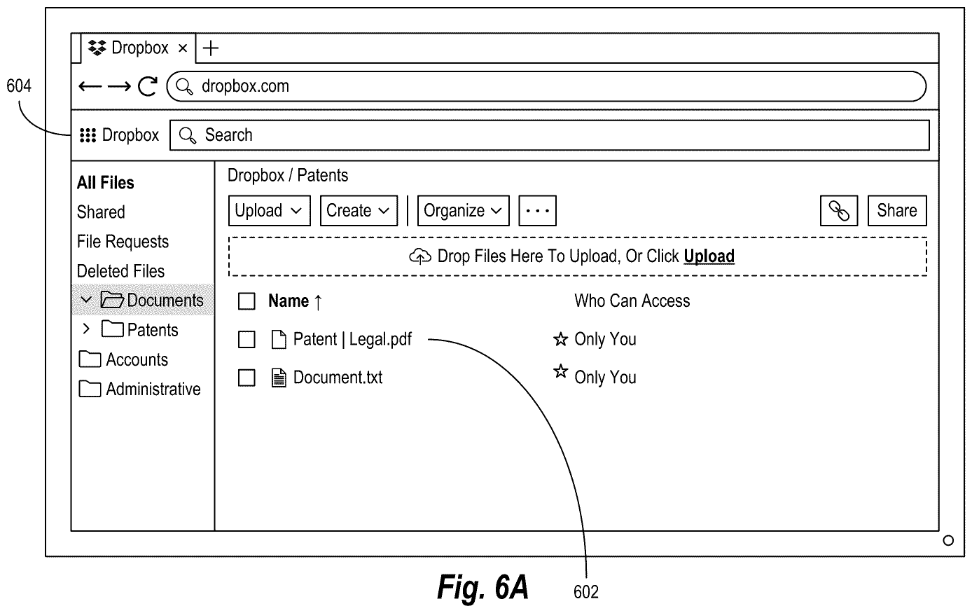

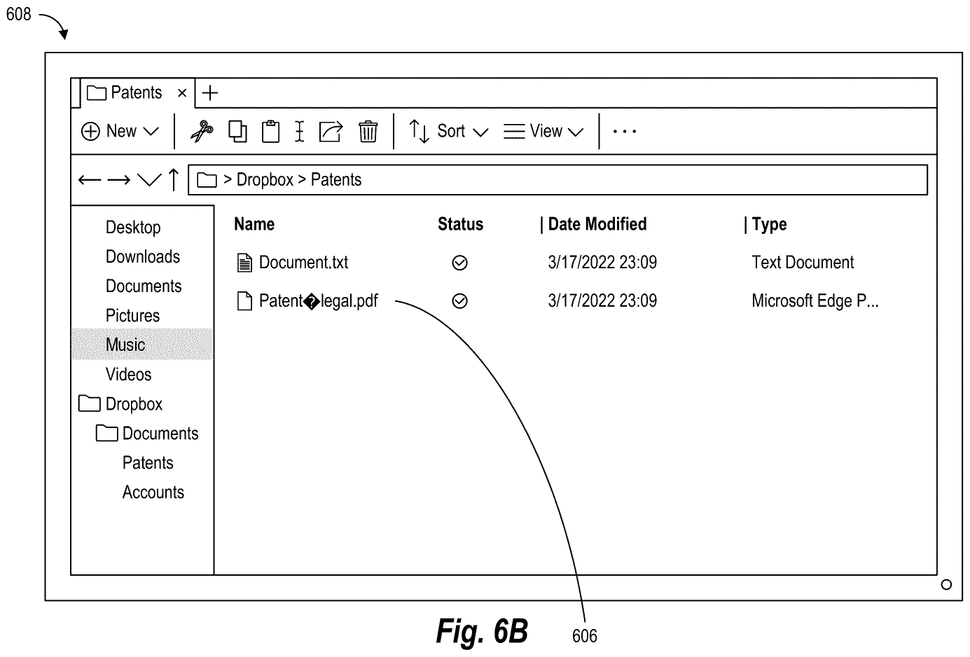

In some embodiments, the intelligent file mapping system 100 also displays a filename corresponding to the device or server on the respective device or server. For example, the intelligent file mapping system 100 displays original filename 102 within interfaces associated with first location 106 and displays compatible filename 110 within interfaces associated with second location 112. Additional details regarding the intelligent file mapping system 100 displaying filenames associated with the corresponding location are provided below with respect to FIGS. 6A-6B.

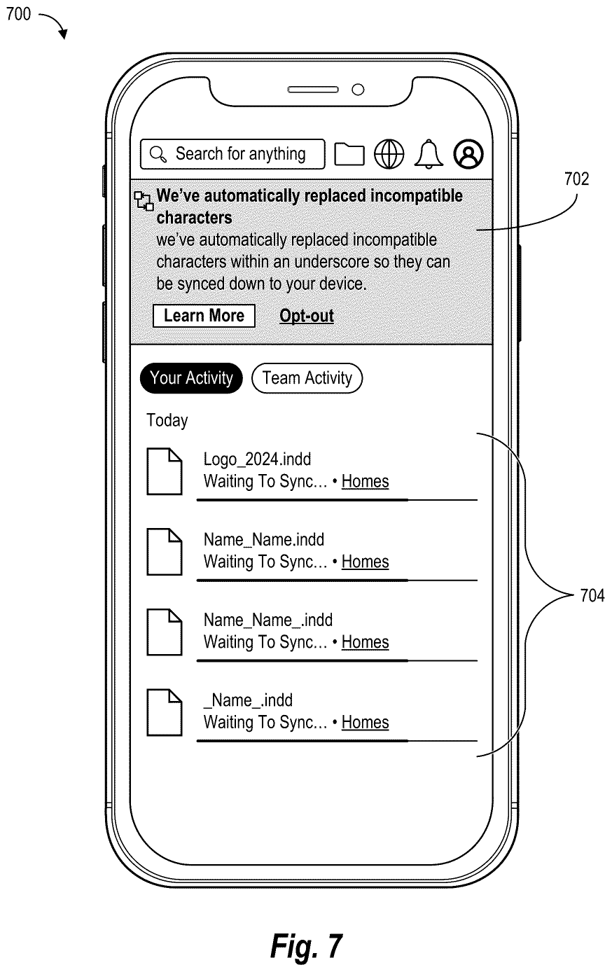

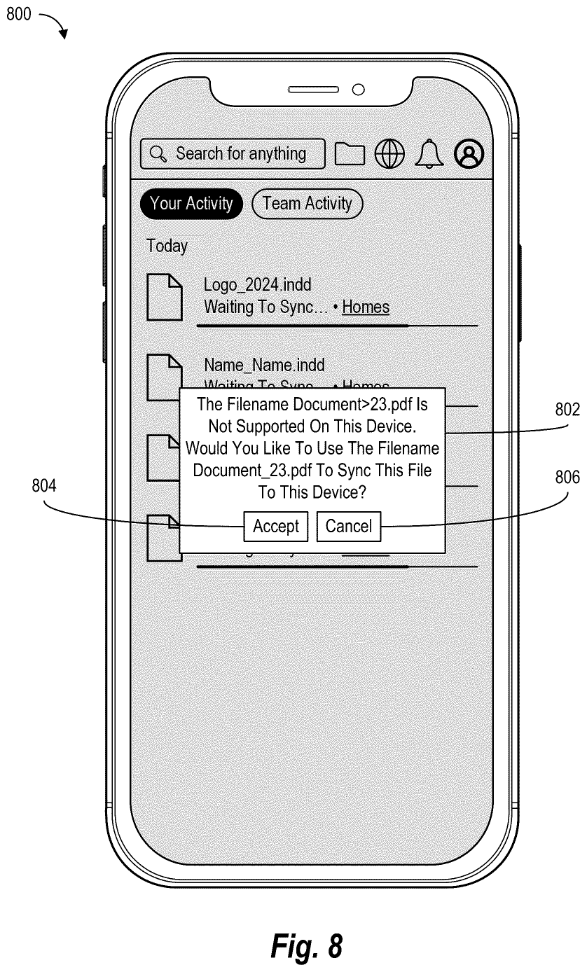

In addition, in one or more embodiments, the intelligent file mapping system 100 provides notifications regarding modifications to filenames based on filename conventions 108. For example, the intelligent file mapping system 100 provides a notification that indicates the intelligent file mapping system 100 generated compatible filename 110 to for content item 104 at second location 112. As another example, the intelligent file mapping system 100 provides a notification with an indication of compatible filename 110 and provides options to accept the modification of original filename 102 to compatible filename 110. Additional details regarding the intelligent file mapping system 100 providing notifications regarding compatible filenames are provided below with respect to FIG. 7 and FIG. 8.

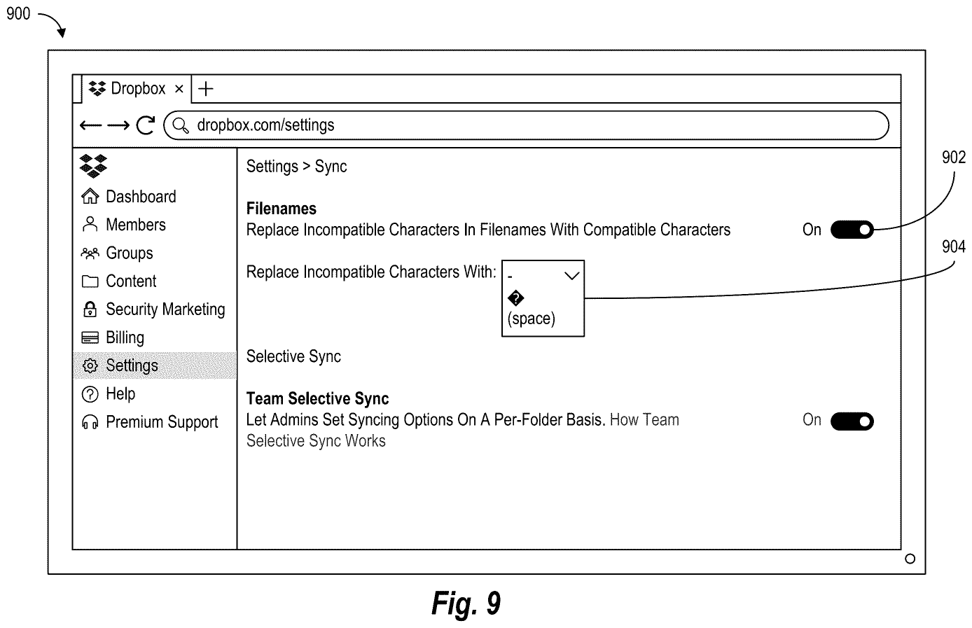

Moreover, in some embodiments, the intelligent file mapping system 100 generates compatible filename 110 based on user preferences. In particular, the intelligent file mapping system 100 provides options within a filename preference interface for generating compatible filename 110 for content item 104 when synchronizing content item 104. For example, the intelligent file mapping system 100 generates a compatible filename based on identifying that a user preference consenting to modifications of filenames that do not conform to filename conventions for the storage location. Additional details regarding the intelligent file mapping system 100 receiving selections of user preferences and generating compatible filenames are provided below with respect to FIG. 9.

The issue of incompatible filename conventions is a problem that specifically arose in the field of file and data storage. Indeed, the issue arises because hardware, software, and other systems are developed by different companies and entities. While industry standards are adopted in many circumstances, technical preferences and requirements of various systems often create incompatible situations. The intelligent file mapping system 100 solves the filename incompatibility problem using a technical solution of intelligent compatible filename generation, along with file mapping schemes, to overcome the technical limitations and technical problems that arose in the field of file and data storage systems.

The intelligent file mapping system 100 provides a variety of additional technical advantages relative to conventional systems. Unlike conventional storage systems that are limited in synchronizing digital items due to characters in filenames, the intelligent file mapping system 100 generates compatible filenames and maps them to original filenames, allowing the intelligent file mapping system 100 to synchronize content items at storage locations on various operating systems. Specifically, the intelligent file mapping system 100 generates compatible filenames that conform to filename conventions for a storage location and also generates a filename mapping to maps the compatible filename at the storage location to an original filename at an original storage location.

In addition, the intelligent file mapping system 100 improves accuracy relative to conventional storage systems. Specifically, unlike conventional storage systems, that fail to synchronize content items and then provide inaccurate folders, missing digital items, and inaccurate listings of digital items, the intelligent file mapping system 100 generates compatible filenames and filename mappings that allow the intelligent file mapping system 100 to accurately synchronize digital items. For example, the intelligent file mapping system 100 generates a compatible filename that is compatible with filename conventions of an operating system that executes the native file management system so that intelligent file mapping system 100 may synchronize content items with the native file management system. Moreover, the intelligent file mapping system 100 generates a filename mapping that accurately maps an original filename to a compatible filename so that changes are accurately propagated to a content item at various storage locations.

Moreover, unlike conventional storage systems that indicate that a content item is in one location but fail to synchronize the other content item, the intelligent file mapping system 100 accurately represents a mirror of content items from another location. Specifically, because the intelligent file mapping system 100 generates compatible local filenames that can synchronize with various operating systems, the intelligent file mapping system 100 can synchronize content items and thus generating a more accurate mirror of content items at another storage location. For example, the intelligent file mapping system 100 stores a content item at a server with the original filename and stores displays the content item at a client device with a compatible local filename, so the client device accurately mirrors the content item at both storage locations. In addition, the intelligent file mapping system 100 provides various notification within a user interface to indicate modifications to an original file name, so that it is clear on the client device what modifications the intelligent file mapping system 100 made to the original filename to generate the compatible local filename.

In addition, the intelligent file mapping system 100 improves efficiencies relative to conventional storage systems. In particular, unlike conventional storage systems that utilize excess processing and computing power generating multiple interfaces as client devices attempt to identify content items that were not synchronized, by accurately synchronizing content items to multiple operating systems, the intelligent file mapping system 100 does not require excess generating of interfaces. For example, because the intelligent file mapping system 100 generates a compatible local filename that synchronizes to a storage location and a filename mapping that maps an original filename at a first storage location to the compatible local filename at a second location, the content item is displayed at the second location. Because the content item is accurately displayed, client devices have no need to initiate additional interface and perform additional operations to identify storage locations for the content item.

As illustrated by the foregoing discussion, the present disclosure utilizes a variety of terms to describe features and advantages of the intelligent file mapping system. Additional detail is now provided regarding the meaning of such terms. For example, as used herein, the term “content item” or “digital item” refers to a digital object or a digital file that includes information interpretable by a computing device (e.g., a client device) to present information to a user. A content item can include a file such as a digital text file, a digital image file, a digital audio file, a webpage, a website, a digital video file, a web file, a link, a digital document file, or some other type of file or digital object. A content item can have a particular file type or file format, which may differ for different types of digital content items (e.g., digital documents. digital images, digital videos, or digital audio files). In some cases, a content item can refer to a remotely stored (e.g., cloud-based) item or a link (e.g., a link to a cloud-based item or a web-based content item) and/or a content clip that indicates (or links) a discrete selection or segmented portion of content from a webpage or some other content item or source. A content item can be editable or otherwise modifiable and can also be sharable from one user account (or client device) to another. In some cases, a content item is modifiable by multiple user accounts (or client devices) simultaneously and/or at different times.

In addition, as used herein, the term “filename” refers to an identifier assigned to a file, content item, or other digital object when it is stored or saved within a digital storage system. In particular, the term “filename” can include a unique identifier or label that helps organize, locate, and manage a digital object within a directory, folder, or other storage structure within a computing device, cloud storage, external device, content management system, or other digital storage system. A file name can distinguish digital objects from other objects stored at the same location or to identify a file stored (or synchronized) among multiple locations. Further, a filename can include various letters, numbers, symbols, or other characters as dictated by the storage system or device on which the digital object is being stored. The term filename can refer to the base name of a digital object and the extension that indicates a file format or type for a digital object or to the base name (e.g., and not the extension).

Relatedly, as used herein, the term “original filename” refers to a unique identifier for a digital object at a storage location when the digital object is saved. Specifically, the term “original filename” can refer to a filename for a digital object prior to synchronizing to another storage system, computing device, or storage system. For example, the term original filename refers to a filename of a digital object prior to modification of the filename to synchronize to another digital storage system, computing device, or content management system.

Similarly, as used herein, the term “compatible filename” refers to a filename that is modified to conform to constraints or rules of the storage system to which a digital object is being stored. In particular, the term “compatible filename” refers to a filename that was modified from an original (or initial) version of a filename of a digital at a first location so that the digital object can be synchronized, stored, or displayed to a second location. In some cases, a compatible filename includes a filename in which characters of an original filename are replaced, removed, or otherwise modified to conform with conventions, constraints, or rules for filenames at an additional location. Relatedly, as used herein, the term “compatible local filename” refers to a filename that is modified for storing a digital object directly on a computing device or physical storage device.

As used herein, the term “updated filename” refers to a filename that was modified in by a user interaction. In particular, the term “updated filename” refers to a filename for which a user interaction, added, removed, or edited characters of a filename. For example, an updated filename can include a modification to a base name of a filename that describes the contents of digital object. Correspondingly, as used herein the term “updated local filename” refers to a modified version of a filename for a digital object stored directly on a computing device or physical storage device, where the filename is modified based on a user interaction with the computing device or physical storage device.

Also, the term “updated original filename” refers to a modified version of a filename for a digital object prior to modifying the filename to synchronize to a separate location with different constraints or rules for filenames. In particular, the updated original filename can reflect modifications to an original filename that reflect user interactions with a compatible filename. For example, the term updated original filename refers to an original filename that is modified by adding or removing portions of the original filename to reflect user interactions with (or modifications of) a compatible filename.

As used herein, the term “filename conventions” refers to a set of rules that govern the structure, format, and characters that can be used for filenames of digital objects stored on a computing device, cloud storage system, or other digital storage system. Specifically, the term “filename conventions” refers to conventions, rules, or constraints that define what characters may or may not be included in a filename, filename length, restrictions on certain filenames, or prohibiting certain filename extensions. For example, filename conventions may indicate that that less than characters (<), greater than characters (>), colon characters (:), double quote characters (″), forward slash characters (/), backslash characters (\), vertical bar or pipe characters (|), question mark characters (?), and/or asterisk characters (*) are not allowed in filenames for digital objects of a digital object stored on a client device. As another example, filename conventions can indicate a maximum or minimum number of characters for a filename of a digital object stored on a client device.

In addition, as used herein, the term “filename mapping” refers to data that associates or connects filenames of a digital object stored in various storage locations. In particular, the term “filename mapping” refers to data, metadata, or other information associated with a digital object that creates or stores associations of filenames of a digital object stored in different locations or systems and that ensures that changes or interactions in one version of the digital object are reflected across additional instances of the digital object. For example, a filename mapping can reflect a first filename for a digital object that is stored at a first location with a second filename for the digital object that is stored at a second location. The filename mapping connects the instances of the digital object in order to reflect or propagate changes to the digital object in both locations.

Moreover, as used herein, the term “metadata field” refers to data associated with a digital object that provides additional details about the digital object. In particular, the term “metadata field” is a piece of information or data that can be used by various systems or applications to manage, search, or organize digital objects. Metadata fields can be customized or extended to content items to include non-standard attributes or information for a digital object or content items without altering a digital object or content item itself. For example, a metadata field remains associated with a digital object, even when the digital object is moved, copied, or synchronized to another location.

Also, as used herein, the term “data structure” refers to a specialized way of organizing and storing data. Specifically, the term “data structure” refers to the layout of data within various storage devices. For example, a data structure can include arrays, linked lists, stacks, queues, data trees, and/or graphs. In some cases, a data structure refers to a storage system for a content management system that represents multiple structures for storing data or content items from various locations For instance, as used herein, the term “local data structure” refers to a data structure (or portion of a data structure) that stores or synchronizes data from computing device connected to a content management system. A local data structure can store the data or content items stored on a computing device or other physical storage location and connected to a content management system. In addition, as used herein, the term “server data structure” refers to a data structure (or portion of a data structure) that stores or synchronizes data from a server. A server data structure can store data or content items at a server or other remote location of a content management system. Moreover, as used herein, the term “sync data structure” refers to a data structure (or portion of a data structure) that stores or expresses the last known instances of synchronization between a remote data structure and a server data structure. For example, a sync data structure stores or synchronizes a data record of a most recent instance where changes between the local data structure and the remote data structure are reconciled, with no pending changes between a computing device and a local data structure or a server and a server data structure.

Also, as used herein, the term “incompatible character” refers to a character of a filename that violates the rules for filenames. In particular, the term “incompatible character” refers to a symbol, letter, number, icon, or graphical character that rules or conventions of a computing device, system, or application and that, when included in the filename, the computing device, system, or application will result in errors or the inability to save or access a digital object corresponding to the filename. For example, an incompatible character can be one of a set of symbols, letters, numbers, icons, or graphical characters that, when included in a filename, violate rules for filenames for a certain computing device or system.

As used herein, the term “lookalike character” refers to a character that resembles a standard character but is different in code. Specifically, the term “lookalike character” refers to a unicode character (e.g., universal character) that looks like a standard alphanumeric or symbol but does not violate rules or conventions for filenames as incompatible characters would. For example, a lookalike character would utilize a unicode character that resembles the incompatible character but utilizes a different unicode value. To illustrate, for a colon (:) with a unicode value of U+003A, a lookalike character could be U+A789 or U+2236.

Further, as used herein, the term “filename offset” refers to a difference between filenames. In particular, the term “filename offset” refers to a specific portion of text that diverges between filenames, that includes changes in a filename from another filename. For example, an offset can include a changed portion of a filename, such as the changed words, structure, characters, or symbols. To illustrate, for a filename “good_document.pdf” and another filename “good_document_v2.pdf,” the filename offset would include “_v2.”

Additionally, as used herein, the term “filename compatibility” refers to a determination of whether filenames can be merged together without conflict. In particular, the term “filename compatibility” refers to a whether two or more filenames can be combined or merged without overlapping or contradictory changes. In some cases, a filename compatibility is the result of an analysis that determines whether filenames can be merged together. For example, a result from a three-way diff indicates whether a filename merge is clean, indicating that the filenames can be merged without conflict, or not clean, indicating there are contradictions in merging the filenames. In other cases, a filename compatibility is a metric that indicates how seamlessly texts can be integrated, where a lower score indicates fewer changes between the filenames, and a higher score indicates additional changes between the filenames. For example, a score of one indicates a single replacement in a filename, where a score of five indicates five different replacements.

As previously mentioned, the intelligent file mapping system 100 generates a compatible filename for a content item and generates a filename mapping that maps the compatible filename for the content item to an original filename at an additional location. Specifically, in one or more embodiments, the intelligent file mapping system 100 generates a compatible local filename for a content item based on filename conventions for a client device and generates a filename mapping that maps the compatible local filename for the content item at the client device to an original filename for the content item at a server. FIG. 2 illustrates a schematic diagram of an intelligent file mapping system 100 generating a compatible local filename for a content item on a client device and generating a filename mapping to propagate modifications to the content item at a server and a client device in accordance with one or more embodiments.

As shown in FIG. 2, the intelligent file mapping system 100 identifies or receives an original filename 204 for content item 202 stored on server 206. In some embodiments, server 206 is a cloud storage system or content management system (e.g., content management system 1402) for storing content items or other digital items and is connected to client device 212 through a network, API, integration system, or other connection that allows for sending requests, content items, and other data between server 206 and client device 212. For example, server 206, or a content management system associated with server 206, utilizes a client application (e.g., client application(s) 1008a-1008n) that integrates with a file manager on a client device that stores data and/or content items locally on the client device. The client application creates a local synchronize folder that is integrated in file manager interface on the client device and interacts with the file manager to synchronize files between server 206 and client device 212. Indeed, client device 212 can store content items locally in the local synchronize folder or other folders of the client device 212 (e.g., by moving the content items from the local synchronize folder to other folders within the file manager interface).

In one or more embodiments, before synchronizing, copying, or storing content item 202 on client device 212, the intelligent file mapping system 100 accesses or identifies filename conventions 208 for client device 212. In particular, filename conventions 208 are a set of rules or constraints that define characters allowed and/or not allowed for a filename for client device 212. For example, filename conventions 208 can prohibit characters, indicate maximum filename lengths, or minimum filename lengths. In some instances, filename conventions are indicated by an operating system of the client device (e.g., the operating system will not allow certain characters in filenames). In other instances, filename conventions are defined by a file manager, client application, or other system on client device 212.

Based on filename conventions 208, intelligent file mapping system 100 generates compatible local filename 210 that conforms to filename conventions 208. Specifically, the intelligent file mapping system 100 generates compatible local filename 210 by replacing incompatible characters in original filename 204 that the filename conventions 208 indicate are not allowed with compatible characters. In some cases, the intelligent file mapping system 100 replaces incompatible characters with a pre-defined character, such as an underscore character, a lookalike character (e.g., a character associated with unicode that looks like the incompatible character), or a unicode character (e.g., using the same unicode character for each replacement).

In some embodiments, the intelligent file mapping system 100 generates a compatible local filename 210 in order to prevent actions by client device 212. Specifically, the intelligent file mapping system 100 identifies that client device 212 will determine that filenames collide and will modify a filename, so the intelligent file mapping system 100 generates compatible local filename 210. For example, to prevent the client device from determining original filename 204 collides with other files, the intelligent file mapping system 100 generates compatible local filename 210, such as to how client device 212 would likely modify original filename 204.

After generating compatible local filename 210, the intelligent file mapping system 100 synchronizes content item 202 to client device 212. In particular, the intelligent file mapping system 100 saves a version of content item 202 to client device 212, where the version of content item 202 on server 206 uses original filename 204 and the version of content item 202 on client device 212 uses compatible local filename 210. For instance, interactions and modifications of content item 202 will update on server 206 and client device 212, even with the differing filenames on each device.

In some embodiments, the intelligent file mapping system 100 generates a filename mapping 214 to map original filename 204 for content item 202 to compatible local filename 210 for content item 202. In particular, the intelligent file mapping system 100 uses the filename mapping 214 to associate the original filename 204 and compatible local filename 210 so that, upon receiving user interactions indicating modifications, updates, or other changes to content item 202, the intelligent file mapping system 100 can identify content item 202 at server 206 and client device 212 to synchronize modifications. For example, if content item 202 has an original filename 204 of “document: 1983.pdf” at server 206 and a compatible local filename 210 of “document_1983.pdf” on client device 212, the intelligent file mapping system 100 uses filename mapping 214 to identify that they are versions of the same content item, even though they have different filenames.

In one or more embodiments, the intelligent file mapping system 100 generates filename mapping 214 by generating a metadata field 216. Specifically, metadata field 216 is an includes additional metadata beyond standard attributes. Standard metadata can include attributes that help systems organize, manage, and access files efficiently, such as filename, file size, creation date, modification date, file type, and/or permissions. Metadata field 216 can include extended attributes that connect original filename 204 to compatible local filename 210. For example, metadata field 216 includes the original filename 204 with a corresponding location on server 206 (e.g., a folder on server 206) and the compatible local filename 210 with a corresponding location on client device 212 (e.g., a folder on client device 212). Indeed, the intelligent file mapping system 100 generates metadata field 216 that is identifiable by various client devices and various client devices know to look for it.

The intelligent file mapping system 100 can associate filename mapping 214 with content item 202. For instance, in some embodiments, the intelligent file mapping system 100 can use system-specific commands or APIs that allow the filename mapping 214 to be associated with content item 202. For example, some operating systems provide a command that allows the intelligent file mapping system 100 to set, view or remove metadata field 216 (e.g., an xattr command) and attach metadata field 216 directly to content item 202. Other operating systems can store metadata field 216 as an alternate data stream (ADS), separate from content item 202 but attached to the file management system that manages storage of content item 202.

In some cases, the intelligent file mapping system 100 stores filename mapping 214 in a data structure. For example, the intelligent file mapping system 100 can store original filename 204 for content item 202 on server 206 in a server data structure and can store compatible local filename 210 for content item 202 on client device 212 in a local data structure. In some cases, a data structure can be a tree data model that include data trees corresponding to various storage locations and the intelligent file mapping system 100 stores filenames in corresponding data trees. Additional details regarding the intelligent file mapping system 100 utilizing a data structure to store filenames are provided below with respect to FIG. 5.

As shown, in one or more embodiments, the intelligent file mapping system 100 receives interaction 218. Specifically, the intelligent file mapping system 100 receives an indication of interaction 218 with content item 202. In some instances, interaction 218 is a server filename interaction 220, indicating an interaction or modification of a filename of a content item stored on a server. For example, intelligent file mapping system 100 could receive server filename interaction 220 by receiving a modification of original filename 204 for content item 202 stored on server 206. To illustrate, if original filename 204 is “document_88mph,” the intelligent file mapping system 100 can receive server filename interaction modifying original filename 204 to “document_88mph_delorean.pdf.”

In other instances, interaction 218 is an internal content interaction 222 that indicates a user interaction or modification of internal content of a content item. Specifically, internal content interaction 222 indicates a user modification of the data or information that makes up content item 202. Internal content interaction 222 will vary depending on a content type of content item 202. For example, if content item 202 is a document (e.g., a Microsoft Word document), internal content interaction 222 can include a user interaction or modification of the text, images, formatting, or embedded media within the document. As another example, if content item 202 is a video file (e.g., an MP4 file), internal content interaction 222 can include a user interaction modifying the video stream (visual footage), audio tracks, subtitles, and any embedded metadata directly associated with content item 202.

In additional instances, interaction 218 is a compatible local filename interaction 224 indicating an interaction or modification of a compatible local filename on a client device. For example, intelligent file mapping system 100 can receive compatible local filename interaction 224 by receiving a modification of compatible local filename 210 on client device 212. To illustrate, if compatible local filename 210 is “document_101.pdf” and the intelligent file mapping system 100 can receive a compatible local filename interaction 224 modifying compatible local filename 210 to “document_101_v2.”

As illustrated, in response to receiving interaction 218, the intelligent file mapping system 100 can utilize filename mapping 214 to reflect interaction 218. Specifically, the intelligent file mapping system 100 can propagate modifications to content item 202 from interaction 218 to the versions of content item 202 at server 206 and client device 212 using the filename mapping. For example, the intelligent file mapping system 100 identifies the content item 202 using original filename 204 for server 206 and compatible local filename 210 for client device 212, as indicated in the filename mapping.

In addition, the intelligent file mapping system 100 can update filename mapping 214 based on interaction 218. For example, if interaction 218 is a server filename interaction 220 or a compatible local filename interaction 224, the intelligent file mapping system 100 modifies filename mapping 214 to reflect modifications to original filename 204 or compatible local filename 210. In some cases, the intelligent file mapping system 100 modifies the metadata field 216 associated directly with content item 202. In other cases, the intelligent file mapping system 100 modifies a metadata field in stored in an alternate data stream. In additional cases, the intelligent file mapping system 100 removes filename mapping 214 based on interaction 218. For example, if interaction 218 is a compatible local filename interaction 224, the intelligent file mapping system 100 can update original filename 204 to reflect compatible local filename 210 and remove filename mapping 214.

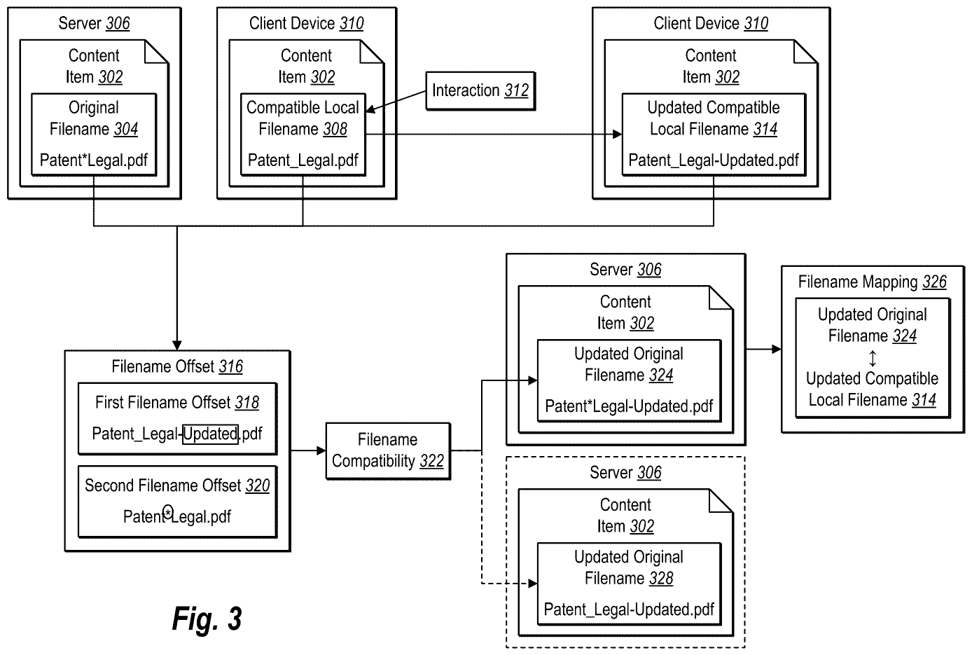

As previously mentioned, the intelligent file mapping system 100 generates a filename offset to generate updated filename. Specifically, the intelligent file mapping system 100 receives an indication of a user interaction with a compatible filename of content item stored at a client device and generates a filename offset to update an original filename of the content item stored at a server. FIG. 3 illustrates a schematic diagram of an intelligent file mapping system generating a filename offset based on an updated local filename and utilizing the filename offset to generate an updated original filename in accordance with one or more embodiments.

As shown in FIG. 3, the intelligent file mapping system 100 (and/or content management system 1402) can store content item 302 on server 306 with original filename 304 and can also store content item 302 on client device 310 with compatible local filename 308. Based on receiving interaction 312, the intelligent file mapping system 100 generates updated compatible local filename 314 for content item 302 on client device 310. In particular, the intelligent file mapping system 100 receives interaction 312 at the client device that modifies compatible local filename 308 to updated compatible local filename 314. For example, interaction 312 can include a user interaction adding characters to compatible local filename 308. To illustrate, for original filename 304 “Patent*Legal.pdf,” the intelligent file mapping system 100 can generate “Patent_Legal.pdf” as compatible local filename 308 to store and/or synchronize content item 302 to client device 310, as described above in relation to FIG. 2. Upon receiving interaction 312, the intelligent file mapping system 100 modifies compatible local filename 308 to generate updated compatible local filename 314 “Patent_Legal-updated.pdf.”

As shown, the intelligent file mapping system 100 can generate filename offset 316. In particular, the intelligent file mapping system 100 generates filename offset 316 that indicates changes or modifications between filenames from interaction 312. For instance, filename offset 316 can indicate a character, or set of characters, added to a filename. As another example, filename offset 316 can indicate a character, or set of characters, removed or deleted from a filename. In one or more embodiments, the intelligent file mapping system 100 generates filename offset 316 by comparing filenames to determine instances where characters have been added or deleted. For example, the intelligent file mapping system 100 compares an original filename, a compatible local filename, and an updated local filename to determine a filename offset of the additions or deletions of characters.

As shown, in some cases, the intelligent file mapping system 100 generates multiple filename offsets when generating filename offset 316. Specifically, the intelligent file mapping system 100 compares different combinations of filenames and generates filename offsets corresponding to the different combination. For example, the intelligent file mapping system 100 compares compatible local filename 308 “Patent_Legal.pdf” and updated compatible local filename 314 “Patent_Legal-updated.pdf” to generate first filename offset 318 (e.g., “-updated”). The intelligent file mapping system 100 also compares original filename 304 “Patent*Legal.pdf” and compatible local filename 308 “Patent_Legal.pdf” to generate second filename offset 320 (“*” and “_”).

In some embodiments, the intelligent file mapping system 100 generates filename offset 316 by performing a three-way diff operation to compare original filename 304, compatible local filename 308, and updated compatible local filename 314. Specifically, the intelligent file mapping system 100 performs a three-way diff by comparing compatible local filename 308 (e.g., as the base filename) with original filename 304 and updated compatible local filename 314 (e.g., the two modified filenames) and analyzing the changes made in original filename 304 and updated compatible local filename 314 relative to the compatible local filename 308. If changes to original filename 304 and updated compatible local filename 314 relative to compatible local filename 308 do not contradict or conflict, the three-way diff indicates that a merge of the filenames is clean. For example, a three-way diff between original filename 304 “Patent*Legal.pdf,” compatible local filename 308 “Patent_Legal.pdf,” and updated compatible local filename 314 “Patent_Legal-updated.pdf” would indicate the changes are clean because the changes can all be resolved without conflicting (e.g., can add “-updated” to original filename 304 or compatible local filename 308).

As also shown, in one or more embodiments, the intelligent file mapping system 100 generates filename compatibility 322 that indicates whether filenames can be merged without conflicts. Specifically, the intelligent file mapping system 100 generates filename compatibility 322 based on analyzing filename offset 316 to determine if the changes indicated in filename offset 316 overlap or contradict each other. For example, the intelligent file mapping system 100 compares first filename offset 318 and second filename offset 320 to determine whether the offsets contradict each other. Since first filename offset 318 and second filename offset 320 do not contradict each other (e.g., not changing the same character and can each be added independently) and original filename 304 can be modified to “Patent*Legal-updated.pdf,” filename compatibility 322 indicates that the filenames are compatible. The intelligent file mapping system 100 updates content item 302 on server 306 to reflect updated original filename 324 by finding the corresponding location in original filename 304 and adding in characters from first filename offset 318.

If the intelligent file mapping system 100 determines that filenames are not compatible, the intelligent file mapping system 100 can provide a notification to the client device that the filename is not compatible. The intelligent file mapping system 100 can then revert the filename the client device is attempting to change back to how the filename was prior to the attempted changes. For example, if the intelligent file mapping system 100 receives the input from client device 310 modifying compatible local filename 308 to “Pat45_Legeel.pdf,” which is not compatible with “Patent*Legal.pdf,” as it contradicts original filename 304, the intelligent file mapping system 100 will provide a notification to the client device that the filename is not compatible. In some cases, the intelligent file mapping system 100 includes education information in the notification, such as by including a link to education information on why the filename is not compatible.

In one or more embodiments, the intelligent file mapping system 100 generates the filename compatibility 322 based on the results of a three-way diff performed as part of filename offset 316. For example, if the 3-way diff is clean, the intelligent file mapping system 100 determines that the filenames are compatible, thus filename compatibility 322 indicates that the filenames can be merged and the intelligent file mapping system 100 generates updated original filename 324.

As shown, in some embodiments, the intelligent file mapping system 100 updates filename mapping 326 to reflect updated original filename 324. In particular, the intelligent file mapping system 100 updates filename mapping 326 to map updated original filename 324 to updated compatible local filename 314. For example, prior to a modification of original filename 304 to updated original filename 324, filename mapping 326 mapped compatible local filename 308 to original filename 304. After receiving the modification to generate updated compatible local filename 314 and generating updated original filename 324, the intelligent file mapping system 100 updates the filename mapping 326 to map updated compatible local filename 314 to updated original filename 324.

As also shown, in one or more embodiments, the intelligent file mapping system 100 generates updated original filename 328 that matches updated compatible local filename 314. Specifically, if updated compatible local filename 314 conforms to filename conventions for server 306, the intelligent file mapping system 100 can generate updated original filename 328 as a replacement for original filename 304 so that updated compatible local filename 314 and updated original filename 328 are the same filename. For example, the intelligent file mapping system 100 can update original filename 304 “Patent*Legal.pdf” to updated original filename 328 “Patent_Legal-updated.pdf,” which is the same as updated compatible local filename 314 and complies with filename conventions for client device 310 and for server 306.

In addition, in some embodiments, when the intelligent file mapping system 100 generates updated original filename 328 (that matches updated compatible local filename 314), the intelligent file mapping system 100 also removes a filename mapping. Because updated original filename 328 and updated compatible local filename 314 both reflect the same characters, the intelligent file mapping system 100 (or the content management system 1402) can recognize both digital objects as content item 302 and synchronize content item 302 without the need for the filename mapping. For example, after updating original filename 304 “Patent*Legal.pdf” to updated original filename 328 “Patent_Legal-Updated.pdf” that matches updated compatible local filename 314 “Patent-Legal-Updated.pdf,” the intelligent file mapping system 100 (or the content management system 1402) recognizes both digital objects as content item 302.

As mentioned, the intelligent file mapping system 100 generates a compatible filename when an original filename is incompatible with filename conventions. In particular, the intelligent file mapping system 100 replaces incompatible characters in the original filename with compatible characters to generate a compatible filename. FIG. 4 illustrates a schematic diagram of an intelligent file mapping system replacing characters in an original filename to generate a compatible filename in accordance with one or more embodiments.

As shown in FIG. 4, in one or more embodiments, the intelligent file mapping system 100 can replace an incompatible character in original filename 402 with a permitted character 404 to generate compatible filename 406. In particular, the intelligent file mapping system 100 replaces characters that do not comply with filename conventions with a character that does comply with filename conventions. As illustrated, for example, the intelligent file mapping system 100 can replace an incompatible character “:” in original filename 402 “Patent:legal.pdf” with a permitted character to generate compatible filename 406 “Patent_legal.pdf.” Permitted characters can include an underscore character “_,” a dash character “-,” a space (e.g., a space between characters, as with a space bar on a client device), or a Unicode character (e.g., a black rhombus with a white question.

In addition, as shown in FIG. 4, the intelligent file mapping system 100 can replace an incompatible character in original filename 402 with a lookalike character 408 to generate compatible filename 410. In particular, the intelligent file mapping system 100 replaces an incompatible character in original filename 402 with a character whose appearance is similar to the incompatible character but is not incompatible with filename conventions. For example, the intelligent file mapping system 100 could replace the incompatible character with a unicode character that is different from the incompatible character but looks similar. To illustrate, the intelligent file mapping system 100 could replace a forward slash character “/,” which has a unicode value of U+002F, with a character with unicode values of U+2215 or U+2044.

In one or more embodiments, the intelligent file mapping system 100 maintains a database that maps incompatible characters to lookalike characters. In particular, when the intelligent file mapping system 100 determines a filename has an incompatible character, the intelligent file mapping system 100 accesses the database to identify lookalike characters that can replace the incompatible character. For example, the database can map incompatible characters with various unicode character that follows filename conventions for the client device or server storing the content item. To illustrate, the intelligent file mapping system 100 can map a less than character (<) to U+02C8 or U+2039, a greater than character to U+02C9 or U+203A, a colon character (:) to U+A789 or U+2236, a quotation mark character (″) to U+2033 or U+02EE, a forward slash character (/) to U+2215 or U+2044, a backslash character (\) to U+2216 or U+29F5, a vertical bar character (|) with U+2223 or U+2225, a question mark character (?) with U+0294, U+00BF, U+2E2E, U+2370, U+2753, or U2754, an asterisk character (*) with U+2217 or U+204E, and a period character (.) with U+2219, U+30FB, or U+2024.

In some cases, the intelligent file mapping system 100 replaces incompatible characters in original filename 402 with the same type of replacement character. In some cases, in the intelligent file mapping system 100 can replace incompatible characters in a filename with a permitted character 404 or a lookalike character 408 based on a setting (e.g., at the content management system or the client device). In other cases, the intelligent file mapping system 100 utilizes various different replacement characters, such as by replacing characters with a Unicode character if there is a lookalike character mapped to the incompatible character in a database. If there is not a lookalike character mapped to the incompatible character, the intelligent file mapping system 100 can utilize a permitted character 404.

In one or more embodiments, the intelligent file mapping system 100 makes multiple modifications to original filename 402 to differentiate compatible local filenames. In particular, the intelligent file mapping system 100 may determine that replacing characters in original filename 402 will generate a compatible local filename that conflicts with other filenames, so the intelligent file mapping system 100 adds additional characters to original filename 402. For example, for original filenames “Patent:Legal” and “Patent:>>Legal.pdf,” generating a compatible filename “Patent_Legal.pdf” for both original filenames would cause a conflict in a second (or destination) storage location. In this instance, the intelligent file mapping system 100 could generate “Patent_Legal.pdf” and “Patent_Legal(1).pdf” to differentiate the compatible filenames.

In addition to generating compatible filenames by modifying incompatible characters of filenames, the intelligent file mapping system 100 can also modifying length of a filename. In particular, if filename conventions allow characters of a certain length (e.g., 30 characters), the intelligent file mapping system 100 can modify an original filename to comply with the filename conventions. For example, the intelligent file mapping system 100 can shorten the original filename and add an indicator, such as (1).

As previously mentioned, the intelligent file mapping system 100 can utilize a metadata field that maps an original filename to a compatible filename and can store the metadata field in different places. Specifically, the intelligent file mapping system 100 can store the metadata field in a local data structure and a server to propagate modifications of a content item to various components storing the content item. FIG. 5 illustrates a schematic diagram of an intelligent file mapping system using filename mappings to update a data structure in accordance with one or more embodiments.

As shown in FIG. 5, the intelligent file mapping system 100 includes data structure 502 that includes a server 504 (e.g., server(s) 1002) for remote data structure 506, synchronized data structure 508, and local data structure 510. In particular, remote data structure 506 reflects a most recent state of content items stored at server 504, the local data structure 510 reflect a most recent synchronization state of content items stored on a computing device (in this instance, client device 516), and the synchronized data structure 508 reflect a most recent synchronized stated where the server 504 and the client device 516 were synchronized (e.g., changes and updates from server 504 and client device 516 were reconciled and no further updates are pending). In one or more embodiments, data structure 502 is a tree data model that uses trees for the various synchronization points, such as a remote tree that reflects content items stored on server 504, a local tree that reflects content items stored on a client device (e.g., client device 516), and a synchronized tree that reflects a most recent synchronized state between a sever and a client device.

As shown, data structure 502 stores and/or synchronizes content item 512 in remote data structure 506. For instance, as remote data structure 506 reflects content items stored on server 504, data structure 502 stores content item 512 with original filename 514 on server 504. As also shown, data structure 502 also synchronizes with client device 516. As previously described, the intelligent file mapping system 100 generates a compatible local filename 518 for storing content item 512 on client device 516 and generates filename mapping 520 that maps compatible local filename 518 with original filename 514. For instance, the intelligent file mapping system 100 stores filename mapping 520 within local data structure 510. As modifications and updates occur on to content item 512 on client device 516 or server 504 (through remote data structure 506), the intelligent file mapping system 100 can access filename mapping 520 in local data structure 510 to identify and match original filename 514 and compatible local filename 518.

In some embodiments, filename mapping 520 includes metadata field 522 as an additional metadata field associated with content item 512. For example, the intelligent file mapping system 100 can store metadata field 522 within local data structure 510 and, upon receiving changes from client device 516 and pushing the changes up to server 504, accesses filename mapping 520 by identifying metadata field 522. In some cases, metadata field 522 is associated directly with content item 512 as extended attributes (e.g., xattr) and stored as part of content item 512 in local data structure 510.

In addition, in some cases, the intelligent file mapping system 100 receives an indication of a filename of a content item stored on client device 516 that does not conform to filename conventions for server 504. For example, the intelligent file mapping system 100 can receive an indication of a local filename that contains an icon (e.g., an emoji), for which the intelligent file mapping system 100 generates compatible server filename 524 for storing the content item on server 504, which synchronizes down to remote data structure 506. Additionally, the intelligent file mapping system 100 generates a filename mapping 526 that maps compatible server filename 524 for the content item to the local filename for the content item on client device 516 and/or local data structure 510. The intelligent file mapping system 100 can store filename mapping 526 in remote data structure 506 or can store filename mapping 526 as a metadata field 528 as extended attributes associated with the content item (e.g., xattr).

Further, in one or more embodiments, the intelligent file mapping system 100 can also map filenames between multiple client devices and the server. For instance, client device 516 and client device 530 can both be connected to data structure 502. As illustrated, client device 516 is associated with local data structure 510 (e.g., a tree for client device 516) and, though not illustrated, client device 530 is associated with an additional local tree (e.g., a tree for client device 530) and each tree can map directly to filenames within the client device. For example, for an original filename 514, the intelligent file mapping system 100 can generate compatible local filename 518 for content item 512 at client device 516 that complies with filename conventions for client device 516 and filename mapping 520 that is stored in local data structure 510. The intelligent file mapping system 100 can also generate an additional compatible local filename for content item 512 at client device 530 that complies with filename conventions for client device 530 and an additional filename mapping that is stored on the local tree associated with client device 530. Indeed, because the filename conventions for client device 516 and client device 530 may not align, the intelligent file mapping system 100 utilizes filename mapping 520 and the additional filename mapping to accurately propagate changes to content item 512 from any of client device 516, client device 530, or server 504 and even if original filename 514, compatible local filename 518, and additional compatible local filename all contain different characters.

In one or more embodiments, the intelligent file mapping system 100 can account for possible filename interactions with applications. Specifically, the intelligent file mapping system 100 can generate an updated extension for a filename that will likely conflict with a different device. For example, for a content item on a first device that is associated with an application, the intelligent file mapping system 100 can add a file extension to a filename that will allow the content item to synchronize to an additional device. To illustrate, the intelligent file mapping system 100 can add an extension so that an application that is compatible can open the content item.

As previously mentioned, the intelligent file mapping system 100 generates a compatible filename for a content item from an original filename of the content item stored in a different location. FIGS. 6A-6B illustrate example graphical user interfaces of an intelligent file mapping system displaying an original filename and a compatible filename in accordance with one or more embodiments. In particular, FIG. 6A illustrates an example graphical user interface of an original filename for a content item stored on a server and FIG. 6B illustrates an example graphical user interface of a compatible local filename of the content item stored on a client device.

As shown in FIG. 6A, the intelligent file mapping system 100 displays a content item with original filename 602 in server file manager interface 604. In particular, the intelligent file mapping system 100 displays original filename in a server file manager interface 604 that is associated with a server for storing content items. For example, server file manager interface 604 is a client application for managing digital files and/or digital content. In some cases, the server storing items is associated with a content management system (e.g., content management system 1402) and the server file manager interface is associated with a client application of the content management system (e.g., client application(s) 1008a-1008n).

As illustrated, original filename 602 indicates a filename at the server for the content item. In some cases, the content item is added to the server through the server file manager interface 604 with original filename 602. In other cases, original filename 602 is added (e.g., edited) for the content item within the server file manager interface 604 that complies with server filename conventions.

As shown in FIG. 6B, the intelligent file mapping system 100 displays the content item with compatible local filename 606 within local file manager interface 608. In some embodiments, local file manager interface 608 is a native file manager application on a client device that complies with filename conventions associated with the client device and the server synchronizes content items directly with the native file manager application. For example, a local application on the client device generates a synchronize folder within the file manager application that behaves like folders within the native file manager application but is synchronized with the server. Content items that are added, modified, or deleted in this folder are automatically synchronized with the server. Indeed, through this integration, a client device can manage files locally while also synchronizing them to the server.

As illustrated, the intelligent file mapping system 100 displays the compatible local filename 606 that was generated to comply with the filename conventions of the client device. For example, original filename 602 “Patent|Legal.pdf” does not comply with filename conventions for the client device (e.g., because of the vertical bar character), so the intelligent file mapping system 100 generates compatible local filename 606 that replaces the incompatible character “|” with a unicode character (e.g., the black rhombus with the white question mark). Indeed, the intelligent file mapping system 100 continues to display the original filename 602 in the server file manager interface 604 while displaying the compatible local filename 606 in the local file manager interface 608, using a filename mapping to propagate changes made on the server or the client device.

In one or more embodiments, the intelligent file mapping system 100 displays an indication that indicates the intelligent file mapping system 100 is generating compatible filenames. In particular, the intelligent file mapping system 100 displays a notification that indicates that characters in an original filename are being replaced to generate a filename that is compatible with filename conventions for the storage location. FIG. 7 illustrates an example graphical user interface of an intelligent file mapping system providing an indication that compatible local filenames are replacing original filenames in accordance with one or more embodiments.

As show, the intelligent file mapping system 100 displays indication 702 in a user interface that the intelligent file mapping system 100 is generating a compatible local filename. In particular, indication 702 in file sync interface 700 indicates that characters in an original filename (e.g., on a server) that are incompatible with filename conventions (e.g., of a client device) are being replaced by the intelligent file mapping system 100 with a compatible character. In some cases, the intelligent file mapping system 100 includes an indication of the compatible character in indication 702.

As also shown, file sync interface 700 also includes files 704 that the intelligent file mapping system 100 is synchronizing. In particular, the intelligent file mapping system 100 displays compatible local filenames in file sync interface 700. Indeed, by displaying indication 702 with compatible local filenames in files 704, the intelligent file mapping system 100 maintains an accurate listing of the files it is synchronizing, while also lessening confusion about which files are synchronizing. In one or more embodiments, the intelligent file mapping system 100 displays indication 702 on an initial synchronization of files after changing original filenames to compatible local filenames and additional synchronizations will not display indication 702.

As previously mentioned, the intelligent file mapping system 100 can also provide a collision notification. In particular, the intelligent file mapping system 100 provides a collision notification that indicates that an original filename does not comply with filename conventions. FIG. 8 illustrates an example graphical user interface of an intelligent file mapping system providing a collision notification in a file sync interface in accordance with one or more embodiments.

As shown, the intelligent file mapping system 100 provides collision notification 802 in file sync interface 800. In particular, collision notification 802 indicates that an original filename for a content item does not comply with filename conventions for the storage location to which the intelligent file mapping system 100 is synchronizing the content item. In some cases, as shown, the intelligent file mapping system 100 can also include a compatible local filename in collision notification 802 that will synchronize to the storage location.

As also shown, the intelligent file mapping system 100 can provide option 804 for accepting a change of an original filename to a compatible local filename and an option 806 for declining a change of an original filename to a compatible local filename. Based on a user interaction with option 804, the intelligent file mapping system 100 will synchronize the content item to the storage location. However, a user interaction with option 806 results in a content item not synchronizing to the storage location (e.g. and remaining in a first storage location with the original filename).

As previously mentioned, the intelligent file mapping system 100 can generate compatible filenames based on filename preferences for generating compatible filenames. In particular, the intelligent file mapping system 100 can provides various options as filename preferences for generating compatible filenames. FIG. 9 illustrates an example graphical user interface of an intelligent file mapping system for receiving filename preferences for modifying filenames in accordance with one or more embodiments.

As shown in FIG. 9, the intelligent file mapping system 100 provides an option 902 with filename preferences interface 900 that indicates a user preference for generating compatible filenames. In particular, based on a user selection of option 902, the intelligent file mapping system 100 will replace incompatible characters in original filenames to generate compatible filenames. If the intelligent file mapping system 100 does not detect a user selection of option 902, the intelligent file mapping system 100 does not generate compatible filenames and, thus, does not synchronize the file to the storage location.

Also, as shown in FIG. 9, the intelligent file mapping system 100 provides options 904 of compatible characters for replacing incompatible characters. Specifically, the intelligent file mapping system 100 will generate compatible filenames by replacing incompatible characters in original filenames with a selected compatible character from options 904. For example, if the intelligent file mapping system 100 detects a selection of an underscore character “_” in options 904, the intelligent file mapping system 100 will replace incompatible characters in an original filename with an underscore character.

The intelligent file mapping system 100 can also provide options for allowed characters in filenames. Specifically, the intelligent file mapping system 100 provide options that, when selected, restrict a storage location from using characters that are incompatible with other storage locations. For example, the intelligent file mapping system 100 can restrict filenames that utilize or “:” or “>.”

In addition, in one or more embodiments, the intelligent file mapping system 100 can provide options for generating compatible filenames based on a user account. Specifically, if the user account is an administration account, the intelligent file mapping system 100 can update filename preferences for user accounts with which the administration account is associated. For example, an administration account can update filename preferences for a team associated with the administration account. As another example, an administration account can update filename preferences for generating compatible filenames for an organization. To illustrate, an administration account associated with the content management system 1004 can adjust filename preferences for compatible filenames for the content management system 1004 (e.g., by replacing incompatible characters with a Unicode character or a dash character).

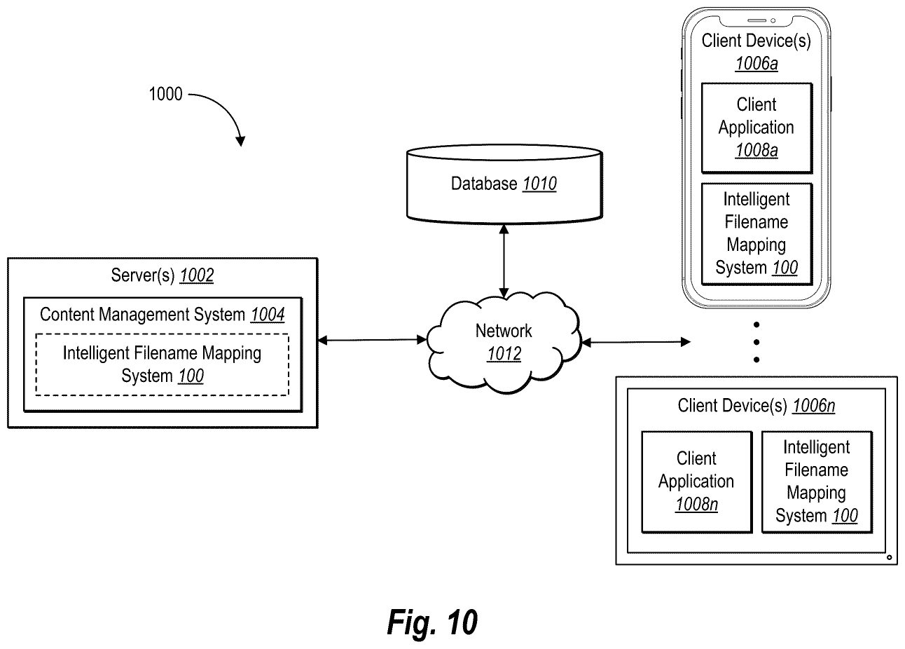

As previously mentioned, the intelligent file mapping system 100 generates a filename mapping that can propagate modifications to a content item stored in various locations. In particular, the intelligent file mapping system 100 utilizes various devices, servers, and networks for storing, synchronizing, and communicating regarding content items. FIG. 10 illustrates a schematic diagram of an environment in which an intelligent file mapping system can operate in accordance with one or more embodiments.

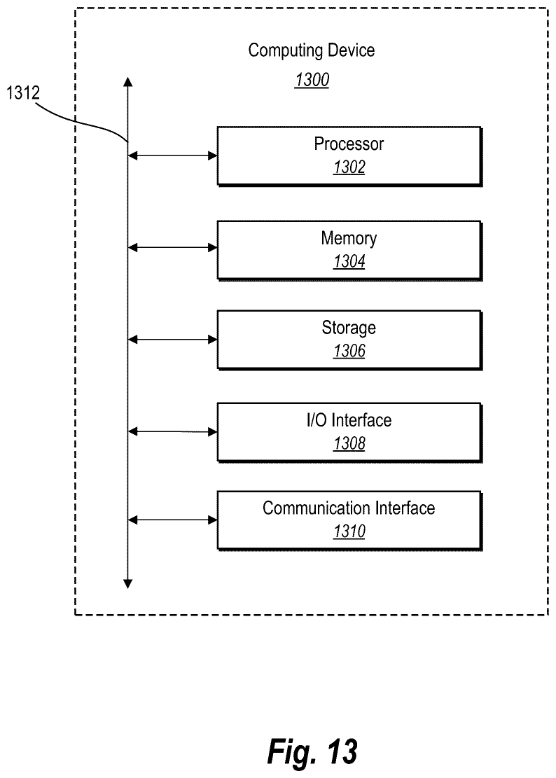

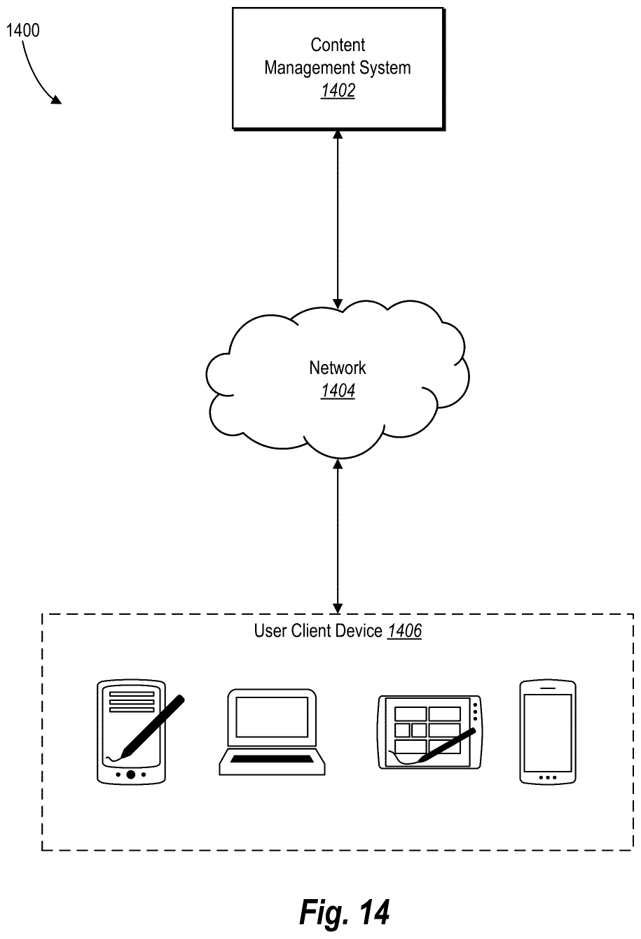

As shown, the environment 1000 includes server(s) 1002, database 1010, and client device(s) 1006a-1006n. Each of the components of the environment 1000 can communicate via network 1012 and network 1012 may be any suitable network over which computing devices can communicate. Example networks are discussed in more detail in relation to FIGS. 13-14.

As mentioned above, the environment 1000 includes client device(s) 1006a-1006n. The client device(s) 1006a-1006n can be one of a variety of computing devices, including a smartphone a tablet, a smart television, a desktop computer, a laptop computer, a virtual reality device, an augmented reality device, or another computing device as described in relation to FIGS. 13-14. The client device(s) 1006a-1006n can communicate with the server(s) 1002 via network 1012. For example, the client device(s) 1006a-1006n can receive user input from a user interacting with client device(s) 1006a-1006n (e.g., via the client application(s) 1008a-1008n) to, for instance, receive user interactions with content items. In addition, the intelligent file mapping system 100 or the server(s) 1002 can receive information relating to various interactions with content items and/or user interface elements based on the input received by the client device(s) 1006a-1006n.

As shown, the client device(s) 1006a-1006n can include a client application 1008a-1008n. In particular, the client application 1008a-1008n may be a web application, a native application installed on the client device(s) 1006a-1006n (e.g., a mobile application, a desktop application, etc.), or a cloud-based application where all or part of the functionality is performed by the server(s) 1002. Based on instructions from the client application(s) 1008a-1008n, the client device(s) 1006a-1006n can present or display information, including a user interface for interacting with content items and/or filenames of content items. Using the client application(s) 1008a-1008n, the client device(s) 1006a-1006n can perform (or request to perform) various operations, such as displaying compatible filenames.

As illustrated in FIG. 10, the environment 1000 also includes the server(s) 1002. The server(s) 1002 may generate, track, store, process, receive, and transmit electronic data, such as filenames (e.g., compatible filenames, original filenames, updated filenames), interactions with interface elements, and/or interactions between user accounts or client devices. For example, the server(s) 1002 may receive an indication from the client device(s) 1006a-1006n of a user interaction modifying the internal content of a content item, a modification to a filename, or selections of options for generating compatible filenames. In addition, the server(s) 1002 can transmit data to the client device(s) 1006a-1006n in the form of a compatible filename or an interface for interacting with the content items. Indeed, the server(s) 1002 can communicate with the client device(s) 1006a-1006n to send and/or receive data via network 1012. In some implementations, the server(s) 1002 comprise(s) a distributed server where the server(s) 1002 include(s) a number of server devices distributed across the network 1012 and located in different physical locations. The server(s) 1002 can comprise one or more content servers, application servers, container orchestration servers, communication servers, web-hosting servers, machine learning servers, and other types of servers.

As shown in FIG. 10, the server(s) 1002 can also include the intelligent file mapping system 100 as part of the content management system 1004. The content management system 1004 can communicate with the client device(s) 1006a-1006n to perform various functions associated with the client application(s) 1006a-1006n, such as managing user accounts and/or identifying content items. Indeed, content management system 1004 can include a network-based smart cloud storage system to manage, store, and maintain content items and related data across numerous user accounts. In some embodiments, the intelligent file mapping system 100 and/or the content management system 1004 utilize the database 1010 to store and access information such as content items and/or filename mappings.

Although FIG. 10 depicts the intelligent file mapping system 100 located on the server(s) 1002, in some implementations, the intelligent file mapping system 100 may be implemented by (e.g., located entirely or in part on) one or more other components of the environment. For example, the intelligent file mapping system 100 may be implemented as part of client device(s) 1006a-1006n and/or a third-party system. As another example, the client device(s) 1006a-1006n and/or a third-party system can download all or part of the intelligent file mapping system 100 for implementation independent of, or together with, the server(s) 1002.

In some implementations, though not illustrated in FIG. 10, the environment 1000 may have a different arrangement of components and/or may have a different number or set of components altogether. For example, the client device(s) 1006a-1006n may communicate directly with the intelligent file mapping system 100, bypassing network 1012. The environment 1000 may also include one or more third-party systems, each corresponding to a different data source. In addition, the environment 1000 can include the database 1010 located external to the server(s) 1002 (e.g., in communication via the network 1012) or located on the server(s) 1002 and/or on the client device(s) 1006a-1006n.

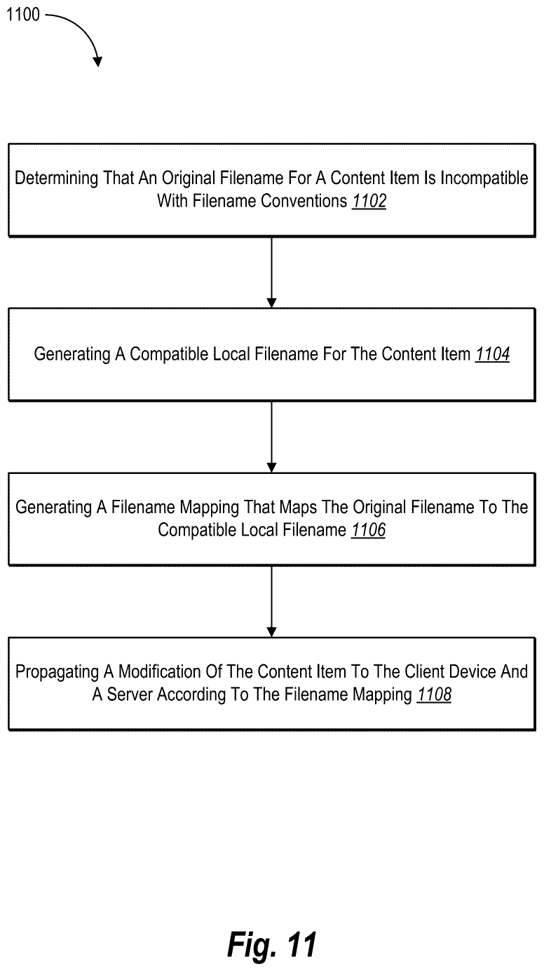

FIGS. 1-10, the corresponding text, and the examples provide a number of different methods, systems, devices, and non-transitory computer-readable media of the intelligent file mapping system 100. In addition to the foregoing, one or more embodiments can also be described in terms of flowcharts comprising acts for accomplishing a particular result, as shown in FIG. 11. FIG. 11 may be performed with more or fewer acts. Further, the acts may be performed in differing orders. Additionally, the acts described herein may be repeated or performed in parallel with one another or parallel with different instances of the same or similar acts.

As mentioned, FIG. 11 illustrates a flowchart of a series of acts 1100 for generating a compatible filename for a content item and generating a filename mapping that associates an original filename for the content item at a first location with the compatible filename for the content item at the second location in accordance with one or more embodiments. While FIG. 11 illustrates acts according to one embodiment, alternative embodiments may omit, add to, reorder, and/or modify any of the acts shown in FIG. 11. The acts of FIG. 11 can be performed as part of a method. Alternatively, a non-transitory computer-readable medium can comprise instructions that, when executed by one or more processors, cause a computing device to perform the acts of FIG. 11. In some embodiments, a system can perform the acts of FIG. 11.

As shown in FIG. 11, the series of acts 1100 includes an act 1102 of determining that an original filename for a content item is incompatible with filename conventions, an act 1104 of generating a compatible local filename for the content item, an act 1106 of generating a filename mapping that maps the original filename to the compatible local filename, and an act 1108 of propagating a modification of the content item to the client device and a server according to the filename mapping.

In particular, the act 1102 can include determining that an original filename for a content item is incompatible with filename conventions associated with a client device, the act 1104 can include based on determining that the original filename is incompatible with the filename conventions associated with the client device, generating, for representing the content item on the client device, a compatible local filename for the content item, the act 1106 can include generating a filename mapping that maps the original filename to the compatible local filename, and the act 1108 can include in response to receiving an indication of an interaction with the content item, propagating a modification of the content item to the client device and a server according to the filename mapping.

For example, in one or more embodiments, the series of acts 1100 includes wherein generating the filename mapping comprises: generating, as a metadata field maintained for the content item locally on the client device, a filename pointer referencing the original filename, and updating a tree data model by replacing the original filename of the content item with the compatible local filename in a local data tree.

In addition, in one or more embodiments, the series of acts 1100 includes wherein generating the filename mapping comprises: generating a metadata field for the content item that maps the original filename to the compatible local filename and associating the metadata field with the content item.

Further, in one or more embodiments, the series of acts 1100 includes receiving an indication of an interaction with the content item by receiving an interaction with the compatible local filename at the client device and in response to receiving the indication of the interaction with the compatible local filename at the client device, generating an updated filename mapping to reflect the modification of the compatible local filename.

Also, in one or more embodiments, the series of acts 1100 includes modifying the original filename according to the updated filename mapping in response to generating the updated filename mapping.

Additionally, in one or more embodiments, the series of acts 1100 includes wherein receiving an indication of the interaction with the content item comprises receiving an indication of an interaction with internal content of the content item, an interaction with the original filename, or an interaction with the compatible local filename.

Moreover, in one or more embodiments, the series of acts 1100 includes providing, within a file sync interface on the client device, a collision notification based on identifying that the original filename for the content item is incompatible with filename conventions for the client device.

In one or more embodiments, the series of acts 1100 includes providing, on the client device, a notification comprising an indication that the original filename is incompatible with the filename conventions for the client device and the compatible local filename and generating the filename mapping based on receiving an indication of a user interaction accepting the compatible local filename.

Also, in one or more embodiments, the series of acts 1100 includes wherein generating the compatible local filename for the content item further comprises: receiving an indication of a user preference consenting to modification of filenames that are incompatible with filename conventions for the client device and generating the compatible local filename based on identifying the user preference consenting to modification of filenames that are incompatible with filename conventions for the client device.

In addition, in one or more embodiments, the series of acts 1100 includes determining that an original filename for a content item stored at a first location is incompatible with filename conventions at a second location based on identifying an incompatible character in the original filename; based on determining that the original filename is incompatible with filename conventions at the second location, generating a compatible filename for storing the content item at the second location by replacing the incompatible character in the original filename with a compatible character, generating a filename mapping that maps the original filename to the compatible filename, and in response to receiving an indication of a modification of the compatible filename, propagating the modification according to the filename mapping.

Additionally, in one or more embodiments, the series of acts 1100 includes replacing the incompatible character in the original filename with the compatible character by replacing the incompatible character with a permitted character, a lookalike character, or a unicode character.

Moreover, in one or more embodiments, the series of acts 1100 includes determining that the original filename is incompatible with the filename conventions by determining that the original filename is incompatible with the filename conventions for a server storing the content item, generate, as a metadata field maintained for the content item in a remote data tree associated with the server storing the content item, a filename pointer referencing the original filename, and updating a tree data model by replacing the original filename of the content item with the compatible filename in the remote data tree.

Further, in one or more embodiments, the series of acts 1100 includes determining that the original filename is incompatible with filename conventions based on determining that the original filename for the content item at a server is incompatible with filename conventions for a client device, and generating the compatible filename by generating a compatible local filename for the content item that is compatible with the filename conventions for the client device and is maintained for the content item locally on the client device.

Also, in one or more embodiments, the series of acts 1100 includes receiving an indication of an interaction with the compatible filename by receiving a modification to the compatible filename to generate an updated compatible filename, based on receiving the indication of the interaction with the compatible filename, compare the compatible filename, the updated compatible filename, and the original filename to generate a filename offset, and based on the filename offset, generate an updated original filename.

Further, in one or more embodiments, the series of acts 1100 includes generating the filename mapping by generating a metadata field for the content item that maps the original filename to the compatible filename and associating the metadata field with the content item.

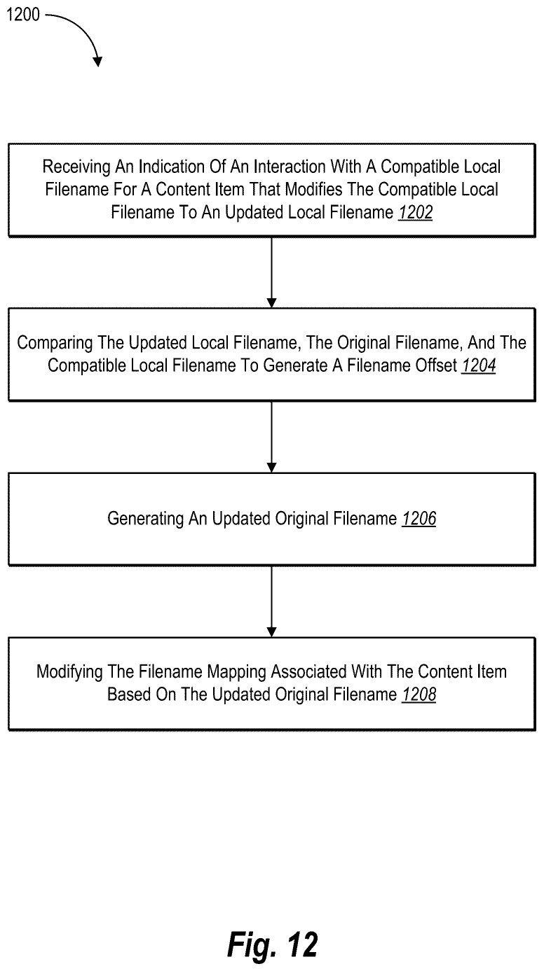

FIGS. 1-11, the corresponding text, and the examples provide a number of different methods, systems, devices, and non-transitory computer-readable media of the intelligent file mapping system 100. In addition to the foregoing, one or more embodiments can also be described in terms of flowcharts comprising acts for accomplishing a particular result, as shown in FIG. 12. FIG. 12 may be performed with more or fewer acts. Further, the acts may be performed in differing orders. Additionally, the acts described herein may be repeated or performed in parallel with one another or parallel with different instances of the same or similar acts.

As mentioned, FIG. 12 illustrates a flowchart of a series of acts 1200 for generating a filename offset to generate an updated original filename in accordance with one or more embodiments. While FIG. 12 illustrates acts according to one embodiment, alternative embodiments may omit, add to, reorder, and/or modify any of the acts shown in FIG. 12. The acts of FIG. 12 can be performed as part of a method. Alternatively, a non-transitory computer-readable medium can comprise instructions that, when executed by one or more processors, cause a computing device to perform the acts of FIG. 12. In some embodiments, a system can perform the acts of FIG. 12.

As shown in FIG. 12, the series of acts 1200 includes an act 1202 of receiving an indication of an interaction with a compatible local filename for a content item, an act 04 of comparting the updated local filename, the original filename, and the compatible local filename to generate a filename offset, an act 1206 of generating an updated original filename, and an act 1208 of modifying the filename mapping associated with the content item based on the updated original filename.

In particular, the act 1202 can include receiving, from a client device, an indication of an interaction with a compatible local filename for a content item that modifies the compatible local filename to an updated local filename, wherein the content item is associated with a filename mapping that maps an original filename for the content item at a server to the compatible local filename for the content item at the client device, the act 1204 can include based on receiving an indication of the updated local filename for the content item, comparing the updated local filename, the original filename, and the compatible local filename to generate a filename offset, the act 1206 can include based on the filename offset, generating an updated original filename, and the act 1208 can include modifying the filename mapping associated with the content item based on the updated original filename.

For example, in one or more embodiments, the series of acts 1200 includes determining the filename offset by comparing the compatible local filename and the updated local filename to determine a first filename offset and comparing the compatible local filename and the original filename to determine a second filename offset.

In addition, in one or more embodiments, the series of acts 1200 includes determining that the filename offset satisfies a filename compatibility; and in response to determining that the filename offset satisfies the filename compatibility, generate the updated original filename from the compatible local filename and the updated local filename.

Also, in one or more embodiments, the series of acts 1200 includes replacing the original filename with the updated original filename and in response to replacing the original filename with the updated original filename, removing the filename mapping from the content item.

Moreover, in one or more embodiments, the series of acts 1200 includes modifying the filename mapping by based on determining that the filename offset does not satisfy a filename compatibility, modifying the original filename at the server to an updated original filename and updating the filename mapping to map the updated original filename to the updated local filename.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., computing device 1300, server(s) 1002, and client device(s) 1008a-1008n). In one or more embodiments, the computing device 1300 may be a mobile device (e.g., a mobile telephone, a smartphone, a PDA, a tablet, a laptop, a camera, a tracker, a watch, a wearable device, etc.). In some embodiments, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 11, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 includes hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 includes storage for storing data or instructions. As an example, and not by way of limitation, the storage device 1306 can include a non-transitory storage medium described above. The storage device 1306 may include a hard disk drive (HDD), flash memory, a Universal Serial Bus (USB) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI. The computing device 1300 can further include a bus 1312. The bus 1312 can include hardware, software, or both that connects components of computing device 1300 to each other.

FIG. 14 is a schematic diagram illustrating environment 1400 within which one or more implementations of the intelligent file mapping system 100 can be implemented. For example, the intelligent file mapping system 100 may be part of a content management system 1402 (e.g., the content management system 1004). Content management system 1402 may generate, store, manage, receive, and send digital content (such as digital content items). For example, content management system 1402 may send and receive digital content to and from client devices 1406 by way of network 1404. In particular, content management system 1402 can store and manage a collection of digital content. Content management system 1402 can manage the sharing of digital content between computing devices associated with a plurality of users. For instance, content management system 1402 can facilitate a user sharing a digital content with another user of content management system 1402.

In particular, content management system 1402 can manage synchronizing digital content across multiple client devices 1406 associated with one or more users. For example, a user may edit digital content using client device 1406. The content management system 1402 can cause client device 1406 to send the edited digital content to content management system 1402. Content management system 1402 then synchronizes the edited digital content on one or more additional computing devices.

In addition to synchronizing digital content across multiple devices, one or more implementations of content management system 1402 can provide an efficient storage option for users that have large collections of digital content. For example, content management system 1402 can store a collection of digital content on content management system 1402, while the client device 1406 only stores reduced-sized versions of the digital content. A user can navigate and browse the reduced-sized versions (e.g., a thumbnail of a digital image) of the digital content on client device 1406. In particular, one way in which a user can experience digital content is to browse the reduced-sized versions of the digital content on client device 1406.

Another way in which a user can experience digital content is to select a reduced-size version of digital content to request the full-or high-resolution version of digital content from content management system 1402. In particular, upon a user selecting a reduced-sized version of digital content, client device 1406 sends a request to content management system 1402 requesting the digital content associated with the reduced-sized version of the digital content. Content management system 1402 can respond to the request by sending the digital content to client device 1406. Client device 1406, upon receiving the digital content, can then present the digital content to the user. In this way, a user can have access to large collections of digital content while minimizing the amount of resources used on client device 1406.

Client device 1406 may be a desktop computer, a laptop computer, a tablet computer, a personal digital assistant (PDA), an in- or out-of-car navigation system, a handheld device, a smart phone or other cellular or mobile phone, or a mobile gaming device, other mobile device, or other suitable computing devices. Client device 1406 may execute one or more client applications, such as a web browser (e.g., Microsoft Windows Internet Explorer, Mozilla Firefox, Apple Safari, Google Chrome, Opera, etc.) or a native or special-purpose client application (e.g., Dropbox Paper for iPhone or iPad, Dropbox Paper for Android, etc.), to access and view content over network 1404.

Network 1404 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1406 may access content management system 1402.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

1. A computer-implemented method comprising:
determining that an original filename for a content item associated with a user account within a content management system is incompatible with filename conventions for a client device associated with the user account;
based on determining that the original filename is incompatible with the filename conventions for the client device associated with the user account within the content management system, generating compatible local filename for representing the content item on the client device;
generating, at the content management system, a filename mapping that maps the original filename to the compatible local filename;
in response to receiving an indication of an interaction with the content item, generating an updated content item at the content management system; and
propagating the updated content item to the client device according to the filename mapping.

2. The computer-implemented method of claim 1, wherein generating the filename mapping comprises:
generating, as a metadata field maintained for the content item locally on the client device, a filename pointer referencing the original filename; and
updating a data structure by replacing the original filename of the content item with the compatible local filename in a local data structure.

3. The computer-implemented method of claim 1, wherein generating the filename mapping comprises:
generating a metadata field for the content item that maps the original filename to the compatible local filename; and
associating the metadata field with the content item.

4. The computer-implemented method of claim 1, further comprising:
associating, in the filename mapping, a second compatible local filename for the updated content item corresponding to a second client device having different filename conventions than the client device; and
propagating the updated content item to the second client device according to the second compatible local filename.

5. The computer-implemented method of claim 1, further comprising:
receiving an indication of an interaction with the compatible local filename at the client device;
in response to receiving the indication of the interaction with the compatible local filename at the client device, generating an updated filename mapping to reflect the modification of the compatible local filename; and
modifying the original filename according to the updated filename mapping in response to generating the updated filename mapping.

6. The computer-implemented method of claim 1, wherein receiving an indication of the interaction with the content item comprises receiving an indication of an interaction with internal content of the content item, an interaction with the original filename, or an interaction with the compatible local filename.

7. The computer-implemented method of claim 1, further comprising providing, within a user interface on the client device, a collision notification based on identifying that the original filename for the content item is incompatible with filename conventions for the client device.

8. The computer-implemented method of claim 1, further comprising:
providing, on the client device, a notification comprising: an indication that the original filename is incompatible with the filename conventions for the client device and an indication of the compatible local filename; and
generating the filename mapping based on receiving an indication of a user interaction accepting the compatible local filename.

9. The computer-implemented method of claim 1, wherein generating the compatible local filename for the content item further comprises:
receiving an indication of a user preference consenting to modification of filenames that are incompatible with filename conventions for the client device; and
generating the compatible local filename based on receiving the indication of the user preference consenting to modification of filenames that are incompatible with filename conventions for the client device.

10. A non-transitory computer-readable medium storing instructions that, when executed by at least one processor, cause a computer system to:
determine that an original filename for a content item associated with a user account within a content management system and stored at a first location is incompatible with filename conventions at a second location associated with the user account based on identifying an incompatible character in the original filename;
based on determining that the original filename is incompatible with filename conventions at the second location associated with the user account within the content management system, generate a compatible filename for storing the content item at the second location by replacing the incompatible character in the original filename with a compatible character;
generate, at the content management system, a filename mapping that maps the original filename to the compatible filename;
in response to receiving an indication of a modification of the compatible filename, generate, at the content management system, an updated content item associated with the content item; and
propagate the updated content item at the second location according to the filename mapping.

11. The non-transitory computer-readable medium of claim 10, further comprising instructions that, when executed by the at least one processor, cause the computer system to replace the incompatible character in the original filename with the compatible character by replacing the incompatible character with a permitted character, a lookalike character, or a unicode character.

12. The non-transitory computer-readable medium of claim 10, further comprising instructions that, when executed by the at least one processor, cause the computer system to:
determine that the original filename is incompatible with the filename conventions by determining that the original filename is incompatible with the filename conventions for a server storing the content item;
generate, as a metadata field maintained for the content item in a remote data tree associated with the server storing the content item, a filename pointer referencing the original filename; and
updating a tree data model by replacing the original filename of the content item with the compatible filename in the remote data tree.

13. The non-transitory computer-readable medium of claim 10, further comprising instructions that, when executed by the at least one processor, cause the computer system to:
determine that the original filename is incompatible with filename conventions based on determining that the original filename for the content item at a server is incompatible with filename conventions for a client device; and
generate the compatible filename by generating a compatible local filename for the content item that is compatible with the filename conventions for the client device and is maintained for the content item locally on the client device.

14. The non-transitory computer-readable medium of claim 10, further comprising instructions that, when executed by the at least one processor, cause the computer system to:
receive an indication of an interaction with the compatible filename by receiving a modification to the compatible filename to generate an updated compatible filename;
based on receiving the indication of the interaction with the compatible filename, compare the compatible filename, the updated compatible filename, and the original filename to generate a filename offset; and
based on the filename offset, generate an updated original filename.

15. The non-transitory computer-readable medium of claim 10, further comprising instructions that, when executed by the at least one processor, cause the computer system to generate the filename mapping by:
generating a metadata field for the content item that maps the original filename to the compatible filename; and
associating the metadata field with the content item.

16. A system comprising:
at least one processor; and
at least one non-transitory computer-readable storage medium storing instructions that, when executed by the at least one processor, cause the system to:
receive, from a client device, an indication of an interaction with a compatible local filename for a content item associated with a user account within a content management system that modifies the compatible local filename to an updated local filename, wherein the content item is associated with a filename mapping that maps an original filename for the content item at a server of the content management system to the compatible local filename for the content item at the client device;
in response to receiving the indication of the interaction, generate, at the content management system, an updated content item associated with the content item;
based on receiving an indication of the updated local filename for the content item associated with the user account within the content management system, compare the updated local filename, the original filename, and the compatible local filename to generate a filename offset;
generate, at the content management system, an updated original filename based on the filename offset; and
modify, within the content management system, the filename mapping associated with the content item based on the updated original filename, such that the updated content item is associated with filename mapping as modified.

17. The system of claim 16, further comprising instructions that, when executed by the at least one processor, cause the system to determine the filename offset by:
comparing the compatible local filename and the updated local filename to determine a first filename offset; and
comparing the compatible local filename and the original filename to determine a second filename offset.

18. The system of claim 16, further comprising instructions that, when executed by the at least one processor, cause the system to:
determine that the filename offset satisfies a filename compatibility; and
in response to determining that the filename offset satisfies the filename compatibility, generate the updated original filename from the compatible local filename and the updated local filename.

19. The system of claim 18, further comprising instructions that, when executed by the at least one processor, cause the system to:
replace the original filename with the updated original filename; and
in response to replacing the original filename with the updated original filename, remove the filename mapping from the content item.

20. The system of claim 16, further comprising instructions that, when executed by the at least one processor, cause the system to modify the filename mapping by:
based on determining that the filename offset does not satisfy a filename compatibility, modifying the original filename at the server to an updated original filename; and
updating the filename mapping to map the updated original filename to the updated local filename.
